(19) United States
(12) Patent Application Publication
(10) Pub. No.: US 2026/0045385 A1
(43) Pub. Date: Feb. 12, 2026

(54) CONDUCTIVE MEMBER

(71) Applicant: Yazaki Corporation, Tokyo (JP)

(72) Inventor: Shinichi YANAGIHARA, Shizuoka (JP)

(73) Assignee: Yazaki Corporation, Tokyo (JP)

(21) Appl. No.: 19/285,539

(22) Filed: Jul. 30, 2025

(30) Foreign Application Priority Data
Aug. 7, 2024 (JP) 2024-131032

(51) Int. Cl. H01B 7/00; H01B 13/00

(52) U.S. Cl. CPC H01B 7/0018; H01B 13/0016

(57) ABSTRACT

A conductive member includes a strip-shaped flat conductor having a bent portion bent in a width direction, a plurality of resin tubes installed to cover a periphery of the flat conductor excluding the bent portion, in which the plurality of resin tubes include a first resin tube configured to cover a first portion of the flat conductor and second resin tube configured to cover a second portion of the flat conductor located adjacent to the first portion, with the bent portion disposed in between, and an adhesive tape wound to block a gap between the first resin tubes and the second resin tube where the bent portion is exposed

### CROSS-REFERENCE TO RELATED APPLICATIONS

This application is based on and claims priority under 35 USC 119 from Japanese Patent Application No. 2024-131032 filed on Aug. 7, 2024, the entire content of which is incorporated herein by reference.

### TECHNICAL FIELD

The present disclosure relates to a conductive member.

### BACKGROUND ART

In the related art, a conductive member that is connected to a power supply such as a battery and supplies electricity to an electrical component or the like has been used in a power supply circuit or the like. Such a type of conductive member may include a strip-shaped flat conductor having a prescribed width.

The conductive member needs to ensure electrical insulation of the flat conductor. For example, there is known a technique of covering a flat conductor with an insulation material and a technique of insulating a flat conductor with a protector made of an insulation resin as disclosed in JP2013-004444A, JP2016-081731A, and JP2023-171187A.

For example, when a busbar is insulated by resin molding, there is a problem that insert molding requires mold costs and manufacturing costs of a conductive member increase.

Further, when a periphery of the busbar is coated with an insulation material, equipment used for coating has a large size, and thus there is a problem that initial equipment costs and manufacturing costs of a conductive member increase.

Therefore, as illustrated in FIG. 6, there is a conductive member 501 as a conductive member having relatively low manufacturing costs, in which a strip-shaped busbar (flat conductor) 510 is inserted into a heat shrinkable resin tube (heat shrinkable tube), and the heat shrinkable tube is heated and heat-shrunk to form an insulation film 520 covering a part of an outer periphery of the busbar 510. The busbar 510 is made of a conductive metal plate having a substantially rectangular cross section, and has a connection hole 514 formed in each of coupling portions at two ends in a longitudinal direction exposed from the insulation film 520.

However, in the conductive member 501, the busbar 510 needs to be inserted through the linearly molded resin tube. Therefore, when the busbar 510 has bent portions 516 bent in a width direction as in a conductive member 502 illustrated in FIG. 7, it is difficult to insert the busbar 510 through the resin tube. In addition, when the busbar 510 is inserted through the resin tube, wrinkles 518 due to bending occur on an inner peripheral side of the resin tube due to a line length difference between an outer periphery and an inner periphery in the bent portions 516 of the busbar 510. Therefore, a dimension of the resin tube may not be stable, the resin tube may cover the coupling portions of the busbar 510, and may fail to cover a necessary range of the busbar 510.

The present disclosure is made in view of the above circumstances, and an object of the present disclosure is to provide a conductive member that can prevent wrinkles from occurring in a resin tube installed to a flat conductor.

### SUMMARY OF INVENTION

A conductive member includes a strip-shaped flat conductor having a bent portion bent in a width direction, a plurality of resin tubes installed to cover a periphery of the flat conductor excluding the bent portion, in which the plurality of resin tubes include a first resin tube configured to cover a first portion of the flat conductor and second resin tube configured to cover a second portion of the flat conductor located adjacent to the first portion, with the bent portion disposed in between, and an adhesive tape wound to block a gap between the first resin tube and the second resin tube where the bent portion is exposed.

According to the conductive member of the present disclosure, it is possible to prevent wrinkles from occurring in a resin tube installed to a flat conductor.

The present disclosure is briefly described above. Details of the present disclosure can be clarified by reading modes (hereinafter, referred to as “embodiments”) for carrying out the disclosure to be described below with reference to the attached drawings.

### BRIEF DESCRIPTION OF DRAWINGS

FIG. 1 is a perspective view illustrating a conductive member according to a first embodiment of the present disclosure;

FIG. 2 is an exploded perspective view of the conductive member illustrated in FIG. 1;

FIG. 3 is a perspective view illustrating a state during assembly of the conductive member according to the first embodiment;

FIG. 4 is a perspective view illustrating a state in which installation of a plurality of resin tubes to a flat conductor is completed;

FIG. 5 is a perspective view illustrating a state in which a plurality of resin tubes are done with being installed to a flat conductor of a conductive member according to a second embodiment of the present disclosure;

FIG. 6 is a perspective view of a conductive member in the related art; and

FIG. 7 is a plan view illustrating a conductive member having bent portions in the related art.

### DESCRIPTION OF EMBODIMENTS

Hereinafter, embodiments of the present disclosure will be described with reference to the drawings.

Conductive members 1, 1A according to the present embodiments are, for example, inter-stack routing modules used for electrical connection between a plurality of battery stacks. It is needless to say that the conductive member 1 of the present disclosure can be applied not only to an inter-stack routing module according to the present embodiment but also to various power supply circuits such as a high-voltage cable that electrically connects a battery assembly and a control device such as an inverter.

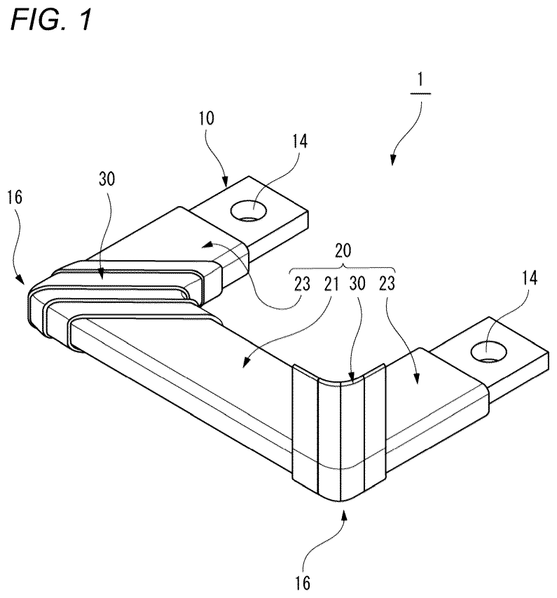

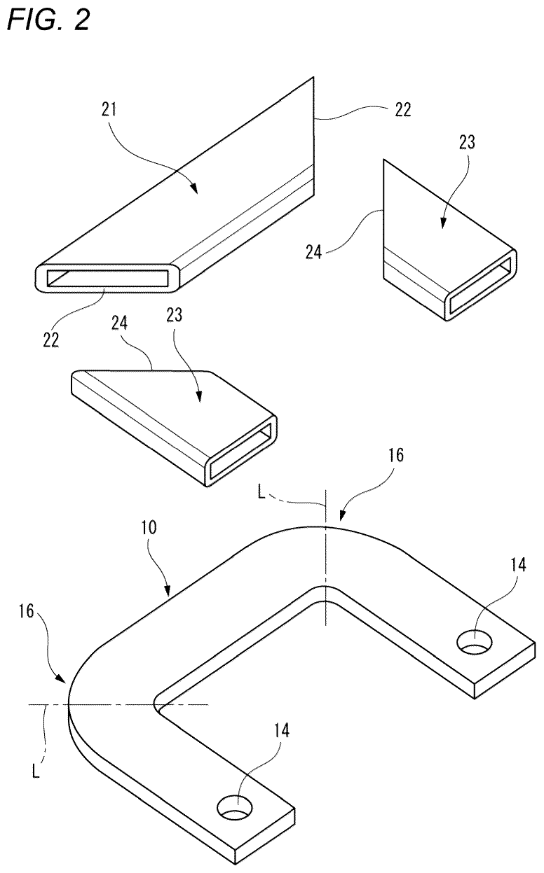

FIG. 1 is a perspective view illustrating the conductive member 1 according to a first embodiment of the present disclosure. FIG. 2 is an exploded perspective view of the conductive member 1 illustrated in FIG. 1.

As illustrated in FIG. 1, the conductive member 1 according to the first embodiment mainly includes a strip-shaped flat conductor (busbar) 10 having bent portions 16 bent in a width direction, a plurality of resin tubes 21, 23 installed to cover a periphery of an intermediate portion of the flat conductor 10 excluding the bent portions, and adhesive tapes 30 wound to block gaps between the resin tube 21 and each of the resin tubes 23.

As illustrated in FIG. 2, the flat conductor 10 according to the first embodiment is formed in a U shape having two bent portions 16 bent in the width direction by edgewise bending a conductive metal plate having a substantially elongated flat plate shape and pressed into a prescribed shape. The flat conductor 10 is formed with, in each of coupling portions at two ends in a longitudinal direction thereof, a connection hole 14 running in a plate thickness direction.

Various conductive metal materials such as copper, a copper alloy, aluminum, and an aluminum alloy can be used for the conductive metal plate.

The plurality of resin tubes 21, 23 according to the first embodiment are heat shrinkable tubes having at least one of electrical insulation and heat resistance. Each of the resin tubes 21, 23 is formed by cutting an elongated heat shrinkable tube molded in a linear shape into a prescribed length.

Whether the resin tubes 21, 23 have one or both of the electrical insulation and the heat resistance (fire resistance) is appropriately selected depending on a use place or a use purpose of the conductive member 1.

Further, the resin tube 21 and the resin tubes 23 are formed with, at end portions adjacent to each other, corresponding oblique cut portions 22, 24 that are parallel to center lines L of the bent portions 16 when the resin tubes are installed to the flat conductor 10.

Next, an assembly procedure of the conductive member 1 will be described.

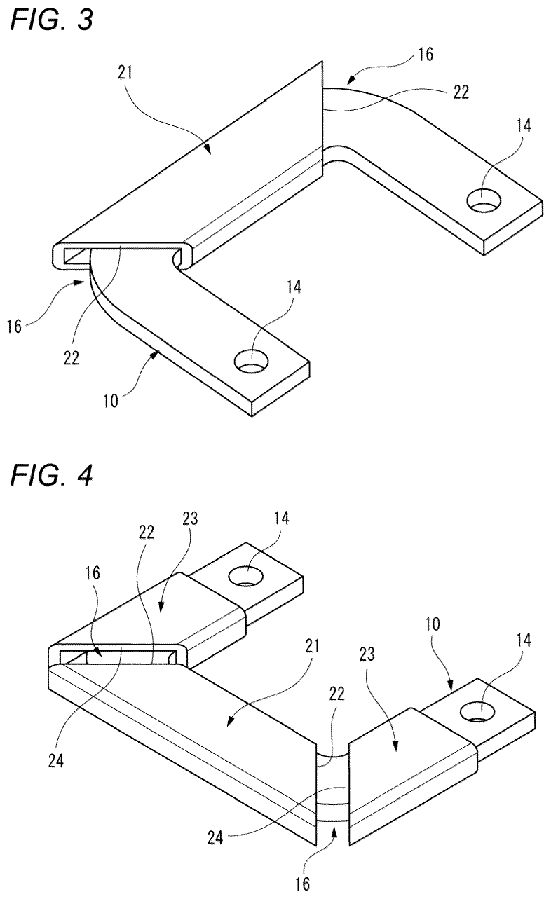

FIG. 3 is a perspective view illustrating a state during assembly of the conductive member 1 according to the first embodiment. FIG. 4 is a perspective view illustrating a state in which installation of the plurality of resin tubes 21, 23 to the flat conductor 10 is completed.

First, as illustrated in FIG. 3, the resin tube 21 is inserted from one end portion of the flat conductor 10 and installed to the intermediate portion of the flat conductor 10. At this time, the resin tube 21 are less likely to be clogged at the bent portions 16 of the flat conductor 10 and can be smoothly installed to the flat conductor 10, since the resin tube 21 has a small total length relative to a total length of the flat conductor 10 and has the oblique cut portions 22 parallel to the center lines L of the bent portions 16.

Next, the resin tubes 23 are inserted from and installed to corresponding two end portions of the flat conductor 10. Therefore, as illustrated in FIG. 4, the plurality of resin tubes 21, 23 are installed to cover a periphery of the intermediate portion of the flat conductor 10 excluding the bent portions 16.

At this time, gaps where the bent portions 16 of the flat conductor 10 are exposed are defined between the oblique cut portions 22 at two end portions of the resin tube 21 and the oblique cut portions 24 of the respective resin tubes 23.

After the resin tubes 21, 23 are heated and heat-shrunk, the adhesive tapes 30 are wound to block the gaps between the resin tube 21 and the resin tubes 23 where the bent portions 16 of the flat conductor 10 are exposed.

Therefore, as illustrated in FIG. 1, an insulation film 20 constituted by the resin tubes 21, 23 and the adhesive tapes 30 is formed on the intermediate portion of the flat conductor 10.

Whether the adhesive tapes 30 have one or both of electrical insulation and heat resistance (fire resistance) is appropriately selected depending on a use place or a use purpose of the conductive member 1.

That is, the insulation film 20 covering the outer periphery of the flat conductor 10 can be easily formed by inserting the flat conductor 10 into the resin tubes 21, 23, heating and heat-shrinking the resin tubes 21, 23, and then winding the adhesive tapes 30 to block the gaps between the resin tube 21 and the resin tubes 23.

Therefore, according to the conductive member 1 in the first embodiment, since the resin tubes 21, 23 do not cover the bent portions 16 of the flat conductor 10, no wrinkles of resin tubes occur at the bent portions 16. For this reason, a dimension of the insulation film 20 is stable, and the insulation film 20 neither covers the coupling portions at the two end portions of the flat conductor 10 nor fails to cover a necessary range of the flat conductor 10.

Next, a conductive member 1A according to a second embodiment of the present disclosure will be described.

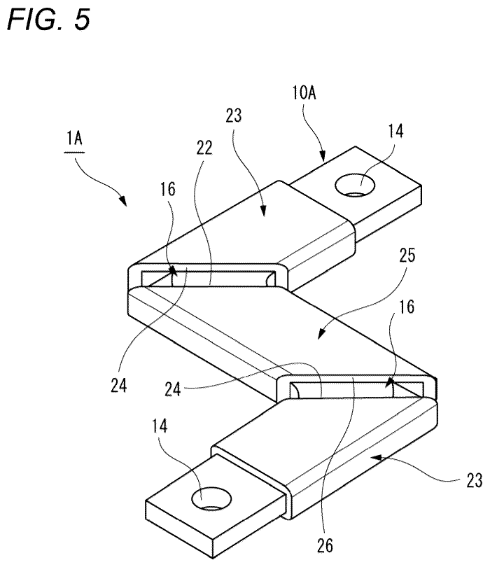

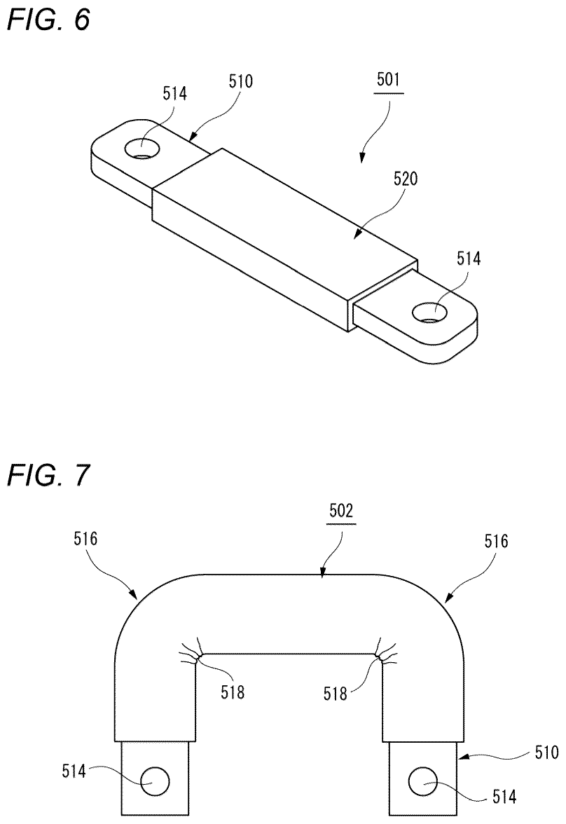

FIG. 5 is a perspective view illustrating a state in which a plurality of resin tubes 23, 25 are done with being installed to a flat conductor 10A of the conductive member 1A according to the second embodiment of the present disclosure. Components of the conductive member 1A similar to those of the conductive member 1 in the first embodiment are denoted by the same reference numerals, and detailed description thereof will be omitted.

As illustrated in FIG. 5, the conductive member 1A according to the second embodiment mainly includes the strip-shaped flat conductor 10A having the bent portions 16 bent in the width direction, the plurality of resin tubes 23, 25 installed to cover a periphery of an intermediate portion of the flat conductor 10A excluding the bent portions 16, and the adhesive tapes 30 (not illustrated) wound to block gaps between the resin tube 25 and each of the resin tubes 23.

The flat conductor 10A according to the second embodiment is formed in a crank shape having the two bent portions 16 bent in the width direction by edgewise bending a conductive metal plate having a substantially elongated flat plate shape and pressed into a prescribed shape.

The plurality of resin tubes 23, 25 according to the second embodiment are heat shrinkable tubes having at least one of electrical insulation and heat resistance. Each of the resin tubes 23, 25 is formed by cutting an elongated heat shrinkable tube molded in a linear shape into a prescribed length.

The resin tube 25 adjacent to the resin tubes 23 is formed with, at two end portions thereof, oblique cut portions 26 that are parallel to the center lines L of the bent portions 16 when the resin tube 25 is installed to the flat conductor 10A. Each of the resin tubes 23 adjacent to the resin tube 25 is formed with, at an end portion thereof, the oblique cut portion 24 that is parallel to the center line L of the bent portion 16 when the resin tube 23 is installed to the flat conductor 10A.

Next, an assembly procedure of the conductive member 1A will be described.

First, the resin tube 25 is inserted from one end portion of the flat conductor 10A and installed to the intermediate portion of the flat conductor 10A. At this time, the resin tube 25 is less likely to be clogged at the bent portions 16 of the flat conductor 10A and can be smoothly installed to the flat conductor 10A, since the resin tube 25 has a small total length relative to a total length of the flat conductor 10A and has the oblique cut portions 26 parallel to the center lines L of the bent portions 16.

Next, the resin tubes 23 are inserted from and installed to corresponding two end portions of the flat conductor 10A. Therefore, the plurality of resin tubes 25, 23 are installed to cover a periphery of the intermediate portion of the flat conductor 10A excluding the bent portions 16.

At this time, gaps where the bent portions 16 of the flat conductor 10A are exposed are defined between the oblique cut portions 26 at two end portions of the resin tube 25 and the oblique cut portions 24 of the respective resin tubes 23.

After the resin tubes 25, 23 are heated and heat-shrunk, the adhesive tapes 30 (not illustrated) are wound to block the gaps between the resin tube 25 and the resin tubes 23 where the bent portions 16 of the flat conductor 10A are exposed. An insulation film constituted by the resin tubes 25, 23 and the adhesive tapes 30 is formed on the intermediate portion of the flat conductor 10A.

Therefore, according to the conductive member 1A in the second embodiment, since the resin tubes 25, 23 do not cover the bent portions 16 of the flat conductor 10A, no wrinkles of resin tubes occur at the bent portions 16. For this reason, a dimension of the insulation film is stable, and the insulation film neither covers coupling portions at two end portions of the flat conductor 10A nor fails to cover a necessary range of the flat conductor 10A.

As described above, according to the conductive members 1, 1A in the present embodiments, it is possible to prevent wrinkles from occurring in the resin tubes installed on the flat conductors 10, 10A.

The present disclosure is not limited to the embodiments described above, and can be appropriately modified, improved, and the like. In addition, materials, shapes, sizes, numbers, arrangement positions, and the like of components in the embodiments described above are freely selected and are not limited as long as the present disclosure can be implemented.

For example, the above embodiments described examples using the resin tubes 21, 23, 25 formed of heat shrinkable tubes. Alternatively, the resin tubes of the present disclosure are not limited to heat shrinkable tubes, and various resin tubes can be used as long as the resin tubes can be installed to cover a periphery of a flat conductor.

In addition, the above embodiments described examples using the flat conductors 10, 10A formed in a U shape or a crank shape. Alternatively, the shapes of the flat conductors of the present disclosure are not limited thereto, and various shapes having one or more bent portions bent in a width direction can be adopted.

Here, features of the conductive member of the present disclosure described above will be briefly summarized and listed in [1] to [3] below.
[1] A conductive member (1, 1A) includes:
a strip-shaped flat conductor (10, 10A) having a bent portion (16) bent in a width direction;
a plurality of resin tubes (21, 23, 25) installed to cover a periphery of the flat conductor (10, 10A) excluding the bent portion (16), in which the plurality of resin tubes (21, 23, 25) include a first resin tube (21, 25) configured to cover a first portion of the flat conductor (10, 10A) and second resin tube (23) configured to cover a second portion of the flat conductor (10, 10A) located adjacent to the first portion (21, 25), with the bent portion (16) disposed in between; and
an adhesive tape (30) wound to block a gap between the first resin tube (21, 25) and the second resin tube (23) where the bent portion (16) is exposed.

According to the conductive member (1, 1A) in [1], since the resin tubes (21, 23, 25) do not cover the bent portion (16) of the flat conductor (10, 10A), no wrinkles of resin tubes occur at the bent portion (16).

In addition, the resin tubes (21, 23, 25) are less likely to be clogged at the bent portion (16) of the flat conductor (10, 10A) and can be smoothly installed to the flat conductor (10, 10A), since each of the resin tubes (21, 23, 25) has a small total length relative to a total length of the flat conductor (10, 10A).
[2] In the conductive member (1, 1A) according to [1], the plurality of resin tubes (21, 23, 25) are formed with, at end portions adjacent to each other, corresponding oblique cut portions (22, 24, 26) parallel to a center line (L) of the bent portion (16).

According to the conductive member (1, 1A) in [2], since the oblique cut portions (22, 24, 26) of the resin tubes (21, 23, 25) are formed at corresponding end portions adjacent to each other, the resin tubes (21, 23, 25) are less likely to be clogged at the bent portion (16) of the flat conductor (10, 10A) and can be more smoothly installed to the flat conductor (10, 10A).
[3] In the conductive member (1, 1A) according to [1] or [2], the resin tubes (21, 23, 25) are heat shrinkable tubes having at least one of electrical insulation and heat resistance.

According to the conductive member (1, 1A) in [3], inserting the flat conductor (10, 10A) into the resin tubes (21, 23, 25) and heating and heat-shrinking the resin tubes (21, 23, 25) can easily form an insulation film (20) that covers a part of an outer periphery of the flat conductor (10, 10A).

What is claimed is:

1. A conductive member comprising:
a strip-shaped flat conductor having a bent portion bent in a width direction;
a plurality of resin tubes installed to cover a periphery of the flat conductor excluding the bent portion, wherein the plurality of resin tubes include a first resin tube configured to cover a first portion of the flat conductor and second resin tube configured to cover a second portion of the flat conductor located adjacent to the first portion, with the bent portion disposed in between; and
an adhesive tape wound to block a gap between the first resin tube and the second resin tube where the bent portion is exposed.

2. The conductive member according to claim 1,
wherein the plurality of resin tubes are formed with, at end portions adjacent to each other, corresponding oblique cut portions parallel to a center line of the bent portion.

3. The conductive member according to claim 1,
wherein the resin tubes are heat shrinkable tubes having at least one of electrical insulation and heat resistance.

4. The conductive member according to claim 2,
wherein the resin tubes are heat shrinkable tubes having at least one of electrical insulation and heat resistance.
